(19) United States
(12) Patent Application Publication
(10) Pub. No.: US 2005/0103837 A1
(43) Pub. Date: May 19, 2005

(54) High-security card and system

(76) Inventor: Charles E. Boyer, Lake Elmo, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/713,247

(22) Filed: Nov. 13, 2003

(51) Int. Cl. G06K 5/00; G06K 19/06

(52) U.S. Cl. 235/380; 235/494

(57) ABSTRACT

A high-security card includes a card body having a perimeter and at least one face. At least one two-dimensional binary information symbol is located within the perimeter of the card body and on the face. A system incorporating the high-security card includes at least one high-security card and at least one card reader that is responsive in use to the symbol of the card. The reader generates a signal that is indicative of the symbol. A decoder receives the signal from the reader, and converts the signal into a human-readable authentication display.

The present invention relates generally to transaction and information cards. The invention relates specifically to a high-security card in which data is presented in a two-dimensional binary information symbol that is capable of being interrogated in multiple orientations, and to a system for reading such a card.

### BACKGROUND OF THE INVENTION

Transaction and identification cards are well known, and have been successfully utilized for conducting business and authenticating personnel for many years.

These cards are typically constructed from durable, planar plastic having a rectangular perimeter, and bear many items of information, typically on each planar face. Valuable and sensitive information presented on these cards may include, for example, a series of alphanumeric characters corresponding to an account number of a named card holder, along with an expiration date (in the case of a transaction card), and a string of so-called biometric and other data pertaining to a named card holder along with the holder's address (in the case of an identification card).

Such cards also commonly include a traditional “Zebra” bar code, which contains information as is well known. Traditional bar codes suffer several drawbacks, however, as is also well known. Among these limitations are:
a tendency for being read erroneously or not at all;
a requirement for nearly perfect orientation in a reader, to be read;
a tendency for a bar code reader to mechanically fail and “trap” a card therewithin; and
a tendency for losing information contained within the code, due to wear and other environmental factors.

Furthermore, in light of the valuable and sensitive data readily available on these cards, and the proliferation of fraudulent and illegal activity undertaken thereby, security and confidentiality issues have become of paramount importance to card holders and issuers alike. Therefore, many attempts have been made to provide “built-in” security provisions for these cards, beyond incorporation of the traditional bar codes. Such built-in security provisions have included personal photographs of the card holders displayed on either face of the card, signature panels, holograms and other elaborate designs, and magnetic strips containing magnetically-readable data. Additionally, so-called “Smart Cards” have been utilized to provide security, particularly in financial transactions. In a Smart Card, a built-in integrated circuit or “computer chip” contains desired data about the card holder and the holder's account or other information.

The aforementioned security provisions which are known in the art have, however, been problematic in that they have been found to be circumvented with little effort, or require expensive and sometimes elaborate computer hardware and software. In addition, due to continuing technological advances, privacy and “tracking” considerations have resulted in elevated concerns for card holders and issuers.

Therefore, with such security drawbacks in mind, it would be desirable to eliminate, as much as possible, readily visible or discernible information from the cards.

It would also be desirable to fabricate the cards as inexpensively as possible.

Therefore, there exists a need for a high-security card in which data is presented in a two-dimensional binary information symbol, and to a system for reading such a card, which overcomes the drawbacks of the known security provisions and which obviates any need for extensive presentation of information on the card itself.

### SUMMARY OF THE INVENTION

An object of the present invention is to provide a high-security card in which data is presented in a two-dimensional binary information symbol, and a system for reading such a card.

Another object of the present invention is to provide a high-security card and system which overcomes the drawbacks of known security provisions.

An additional object of the present invention is to provide a high-security card and system which obviates any need for extensive presentation of information on the card itself.

A further object of the present invention is to provide a high-security card and system which is inexpensive to fabricate and use.

In accordance with the present invention, a high-security card includes a card body having a perimeter and at least one face. At least one two-dimensional binary information symbol is located within the perimeter of the card body and on the face. A system incorporating the high-security card includes at least one high-security card and at least one card reader that is responsive in use to the symbol of the card. The reader generates a signal that is indicative of the symbol. A decoder receives the signal from the reader, and converts the signal into a human-readable authentication display.

### BRIEF DESCRIPTION OF THE DRAWINGS

FIG. 1a is a perspective illustration of a prior art transaction card.

FIG. 1b is a perspective illustration of a prior art identification card.

FIG. 2a is a perspective illustration of an exemplary high-security transaction card, constructed in accordance with the present invention.

FIG. 2b is a perspective illustration of an exemplary high-security identification card, constructed in accordance with the present invention.

FIG. 3a is a perspective illustration of an alternative embodiment of the exemplary high-security transaction card of FIG. 2a, constructed in accordance with the present invention.

FIG. 3b is a perspective illustration of an alternative embodiment of the exemplary high-security identification card of FIG. 2b, constructed in accordance with the present invention.

FIG. 4 is a schematic diagram of an exemplary system in accordance with the present invention, for use with the cards of FIGS. 2a-b and 3a-b.

### DETAILED DESCRIPTION OF THE INVENTION

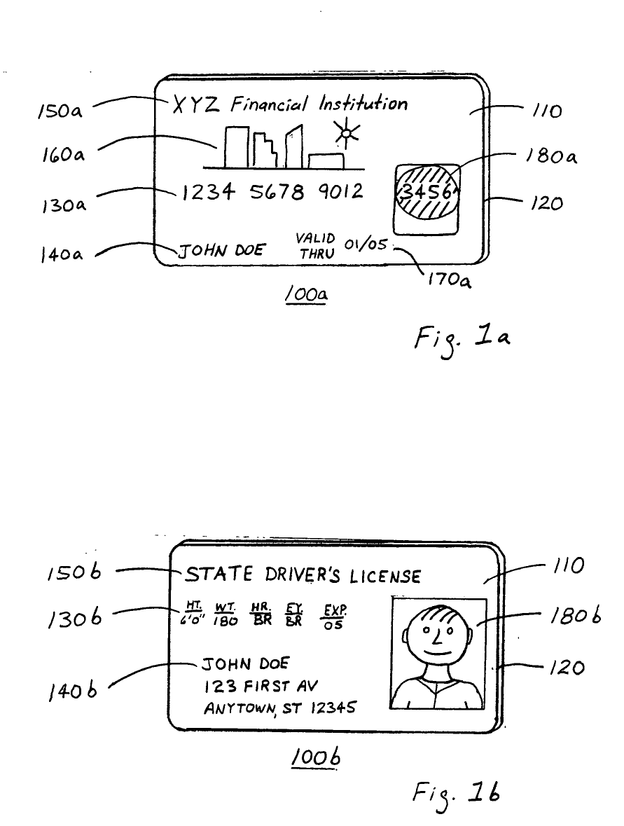

Referring to FIGS. 1a and 1b, there shown is an exemplary prior art transaction card 100a and identification card 100b, respectively. Each card is characterized by a card body 110 and a typically rectangular perimeter 120.

With specific reference to FIG. 1a, transaction card 100a typically includes on its front face a series of alphanumeric characters 130a which corresponds to an account number of a named card holder 140a with the card issuing institution 150a, as shown on the card. It is customary for cards of the type exemplified by card 100a to also bear graphics 160a which are unique to institution 150a, such as a trademark. Additionally, it is customary for card 100a to bear an expiration date 170a.

As aforedescribed, one “built-in” security provision that has been commonly utilized with those cards exemplified by card 100a is a hologram 180a surrounding selected characters 130a.

With reference now to FIG. 1b, identification card 100b typically includes a string of so-called biometric and other data 130b on its front face pertaining to a named card holder 140b, including the holder's address. Usually, issuing authority 150b is prominently displayed on card 100b. It is customary for cards of the type exemplified by card 100b to also bear a photograph 180b of card holder 140b, thereby providing a modicum of built-in security.

Typically, cards 100a-b each have a magnetic strip containing magnetically-readable data, along with a signature panel, on their reverse face (not illustrated).

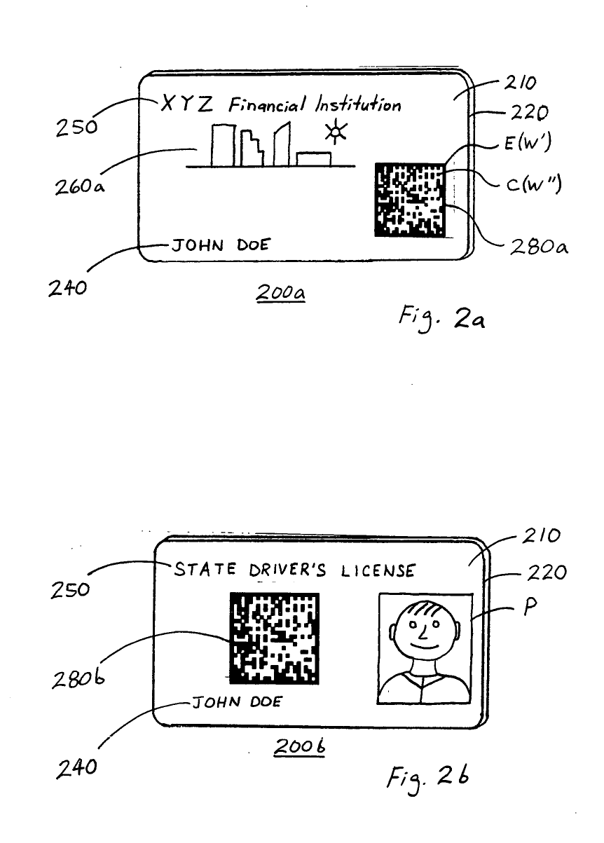

Referring now to FIGS. 2a and 2b, there shown are exemplary embodiments of a high-security card of the present invention, adapted for use as and embodying a high-security transaction card 200a and a high-security identification card 200b, respectively.

As used here throughout, the term “high-security card” is intended to include all identification, transaction, and related cards, such as, for example, DL, VISA, etc.

Each card 200a-b is characterized by a card body 210 having a front face and a reverse face, and a typically rectangular perimeter 220. Depending upon intended uses each card may, but is not required to, bear such indicia as a named card holder 240 and the card issuing institution or authority 250, as shown in the figures. Further indicia may include, as may be desired and shown in FIG. 2a, a trademark or other unique graphic 260a (which, although not illustrated, may also be present as desired in card 200b of FIG. 2b).

With specific reference now to FIG. 2a, high-security transaction card 200a further includes on its front face, within perimeter 220, at least one two-dimensional binary information symbol 280a.

Preferably, two-dimensional binary information symbol 280a is a Vericode® or VS Code™ (also known as “VeriSecure” ™ Code) symbol, each of which are commercially available from Veritec, Inc. of Golden Valley, Minn., a parent company of the assignee of the present invention.

Preferred Vericode® or VS Code™ symbol 280a is characterized as being a two-dimensional symbol comprising a collection of generally equal sized and square data cells C. The data cells C are bordered by at least one solid edge E, having a width W′ that is approximately equal to a width W″ of each of the data cells C. Individual, contrasting (light and dark) cells C represent binary information. Of course, varying binary information from one application to another, results in varying contrasting cells C from one symbol 280a to another.

Details of Vericode® and VS Code™ symbols are described in U.S. Pat. Nos. 4,924,078, 5,331,176, and 5,612,524 issued to Sant'Anselmo, et al.

The Vericode® and VS Code™ symbols themselves essentially differ only in the relative amounts or bits of information that may be represented by each. A Vericode® symbol is capable of representing up to 174 bits of information, while a VS Code™ symbol is capable of representing up to approximately 4,000 bits.

Thus, choice of a Vericode® or VS Code™ symbol depends simply upon the desired amount of information to be represented in the symbol.

Distinct advantages of use of a Vericode® or VS Code™ symbol (hereinafter, collectively, “Vericode® symbol”) for symbol 280a include:
“Data compaction” (fitting more data in less space);
Scalability, allowing each Vericode® symbol to be virtually as large or as small as may be desired;
Readability, allowing each Vericode® symbol to be read from any 360 degree rotational orientation (i.e., a capability of being interrogated in multiple orientations); and
“E.D.A.C.” (Error Detection And Correction), which allows each Vericode® symbol to be correctly decoded even when approximately 25% of cells C in a given symbol are damaged.

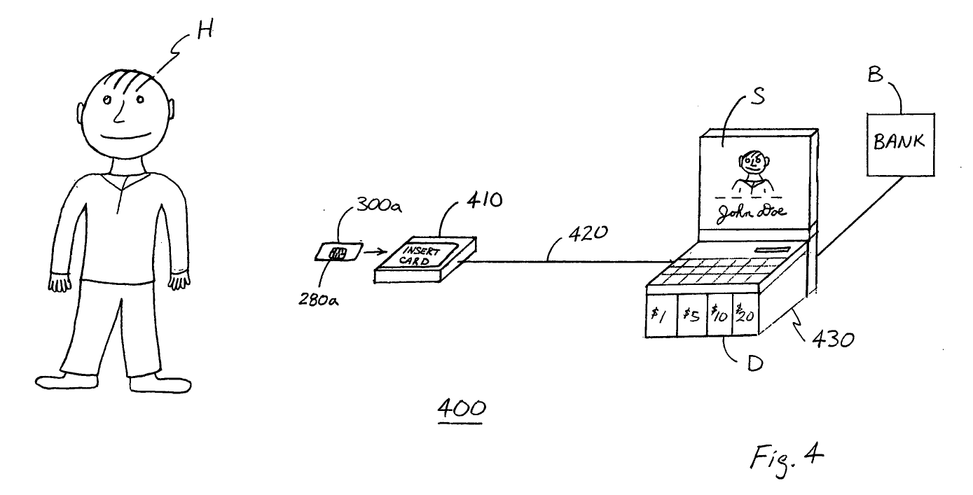

Reading a Vericode® symbol is discussed below, relative to FIG. 4.

With reference now to FIG. 2b, high-security identification card 200b further includes on its front face, within perimeter 220, at least one two-dimensional binary information symbol 280a and, optionally, a photograph P of card holder 240.

As described with respect to card 200a, two-dimensional binary information symbol 280a is preferably a Vericode® symbol, having the aforedescribed contrasting data cells C, and cell and edge constructions and dimensions.

It is therefore to be understood that, with comparative reference to FIGS. 1a and 2a, and to FIGS. 1b and 2b, symbols 280a-b obviate any need for presentation of account, biometric, and other data of cards 10a-b. Further, the aforedescribed “built-in” security provisions of cards 100a-b are not required in exemplary cards 200a-b of the present invention, since the Vericode® symbol is unintelligible without a reading or decoding device. It is to be understood further, then, that the aforedescribed magnetic strip of cards 10a-b would also not be necessary.

Regarding fabrication of cards 200a-b, it is to be understood that they may be constructed from any suitable stock material, such as paper, film, or plastic, depending on particular needs and desired robustness. It may be desirable, in a particular application, to construct cards 200a-b in accordance with the present invention as economical, disposable cards from an inexpensive material such as paper, where longevity is not a concern (e.g., one-time “pit pass” credentials at an automobile race, or where the holder's information is anticipated to frequently change). Preferably, cards 200a-b have so-called “wallet-size” rectangular length and width dimensions of about 3¼′ by 2 1/8′. The thicknesses of the cards depend, of course, upon the choice of stock material.

Thus, it is to be particularly appreciated that cards 200a-b provide high security relative to their traditional counterparts 10a-b, since cards 200a-b bear no useful human-readable information by comparison and therefore are virtually unsusceptible to fraud, theft, and other illegal or unauthorized activity.

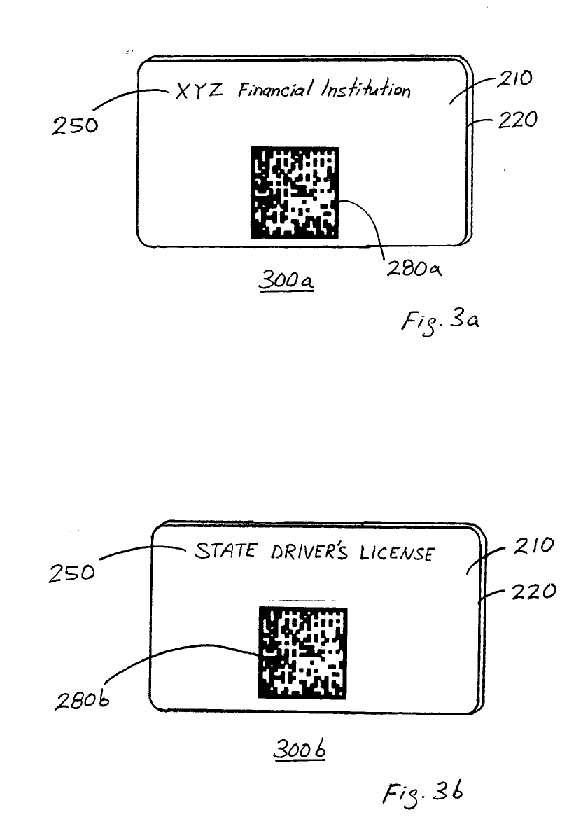

Alternative embodiments of exemplary cards 200a-b are depicted in FIGS. 3a and 3b, respectively, with like reference numerals corresponding to like elements.

In FIG. 3a, card 300a is characterized as having even higher security than card 200a of FIG. 2a, since virtually no human-readable information is displayed thereon. In this example, a VS Code™ symbol 280a represents all pertinent information, and may represent further digital enhancements such as a card holder's photograph, signature, and even fingerprint.

In FIG. 3b, card 300b is similarly characterized as having even higher security than card 200b of FIG. 2b. In this example, a VS Code™ symbol 280b again represents all pertinent information, and may represent further digital enhancements as aforedescribed.

Although cards 200a-b and 300a-b have been described and depicted as embodying high-security transaction and identification cards, it is to be appreciated that other uses thereof are contemplated by the present invention, such as, for example, library patron identification and circulation control (e.g., check-in and check-out of library materials), building access, medical information and patient history, and other data encryption.

Turning now to FIG. 4, an exemplary high-security card system 400 of the present invention (“system 400”) is depicted in a retail setting, as a high-security transaction card system. Exemplary system 400 includes high-security transaction card 300a, card reader 410, signal transmission line 420, and a decoder 430 embodied in a transaction display terminal or so-called “cash register” having a display screen S and a cash drawer D.

In use, as will be further described, card reader 410 is responsive to symbol 280a of card 300a and generates a signal indicative thereof. The signal is transmitted via signal transmission line 420 to decoder 430. Decoder 430 then receives the signal from transmission line 420 and converts the signal into a human-readable authentication display on display screen S.

In a preferred embodiment of system 400, card reader 410 includes VeriWrite™ and VeriRead™ software, each of which is also available from Veritec, Inc.

Specifically in use of exemplary system 400, a card holder H or buyer of goods initiates a transaction by inserting his high-security transaction card 300a into card reader 410 as instructed. Card reader 410 then generates a signal indicative of symbol 280a. That signal is then transmitted via line 420 to decoder 430. Decoder 430 then converts the signal into an authentication display on display screen S, which may be viewed by a clerk (not illustrated) operating the system to authenticate and verify that card 300a in fact belongs to card holder B by virtue of comparison of, for example, a signature, photo, or even fingerprint image that is contained within decoded symbol 280a. The transaction is then completed in a conventional manner, with further financial data of symbol 280a (e.g., account number and expiration date) transmitted to bank B in any well-known credit card-like transaction.

It is to be appreciated that, although not illustrated, system 400 could also comprise (i) a high-security identification card system; (ii) an economical, disposable identification card system; (iii) a library patron identification and circulation control card system; (iv) a building access card system; and (v) a medical information and patient history card system. In this regard, system 400, like cards 200a-b and 300a-b, may be readily adapted for uses other than for high-security transaction and identification cards as aforementioned.

In exemplary system 400, it is to be understood that various suitable components may be substituted for those depicted. For example, a wireless transmission means could be substituted for line 420.

It is to be particularly appreciated and understood from the foregoing description that the present invention overcomes many of the aforedescribed drawbacks involved with utilization traditional “Zebra” bar codes. The Vericode® or VS Code™ symbols, among other things, (i) are not prone to being read erroneously or not at all; (ii) do not require a specific orientation relative to a reader to be read; (iii) do not require utilization of a traditional bar code reader that may mechanically fail and “trap” a card therewithin; and (iv) are not prone to loss of information from wear and other environmental factors.

It is also to be appreciated and understood that symbols and indicia as described in cards 200a-b and 300a-b could of course be provided as well, in any combination, on a reverse face of a given card.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired results, or that various accessories may be added thereto.

Lastly, the choice, of course, of compositions, sizes, and strengths of various aforementioned components of the present invention are all a matter of design choice depending upon intended uses thereof.

Accordingly, these and other various changes or modifications in form and detail of the present invention may also be made therein, again without departing from the true spirit and scope of the invention as defined by the appended claims.

1. A high-security card, comprising:
a card body having a perimeter and at least one face; and
at least one two-dimensional binary information symbol, said at least one symbol being located within said perimeter of said card body on said at least one face.

2. The high-security card of claim 1, adapted for use as a high-security transaction card.

3. The high-security card of claim 1, adapted for use as a high-security identification card.

4. The high-security card of claim 1, adapted for use as an economical, disposable identification card.

5. The high-security card of claim 1, adapted for use as a library patron identification and circulation control card.

6. The high-security card of claim 1, adapted for use as a building access card.

7. The high-security card of claim 1, adapted for use as a medical information and patient history card.

8. A high-security card system, comprising:
at least one high-security card, said high-security card including (i) a card body having a perimeter and at least one face, and (ii) at least one two-dimensional binary information symbol, said at least one symbol being located within said perimeter of said card body on said at least one face;
at least one card reader, said reader being responsive in use to said at least one symbol of said at least one high-security card and generating a signal indicative of said symbol; and
at least one decoder, said decoder being capable of (i) receiving said signal from said at least one card reader, and (ii) converting said signal into a human-readable authentication display.

9. The high-security card system of claim 8, adapted for use as a high-security transaction card system.

10. The high-security card system of claim 8, adapted for use as a high-security identification card system.

11. The high-security card system of claim 8, adapted for use as an economical, disposable identification card system.

12. The high-security card system of claim 8, adapted for use as an economical, disposable identification card system.

13. The high-security card system of claim 8, adapted for use as a library patron identification and circulation control card system.

14. The high-security card system of claim 8, adapted for use as a building access card system.

15. The high-security card system of claim 8, adapted for use as a medical information and patient history card system.
